(19) United States
(12) Patent Application Publication
(10) Pub. No.: US 2006/0130136 A1
(43) Pub. Date: Jun. 15, 2006

(54) Method and system for providing wireless data network interworking

(76) Inventors: Vijay Devarapalli, Sunnyvale, CA (US); Meghana Sahasrabudhe, Sunnyvale, CA (US); Inmaculada Carrion Rodrigo, San Diego, CA (US); Kalle Ahmavaara, San Diego, CA (US)

Correspondence Address: DITTHAVONG & CARLSON, P.C., Suite A, 10507 Braddock Road, Fairfax, VA, 22032, US

(21) Appl. No.: 11/291,388

(22) Filed: Dec. 1, 2005

Related U.S. Application Data
(60) Provisional application No. 60/632,021, filed on Dec. 1, 2004.

(51) Int. Cl. G06F 15/16

(52) U.S. Cl. 726/15

(57) ABSTRACT

An approach is provided for minimizing tunnel overhead across wireless networks. a method comprises accessing a first wireless network. Using a first wireless network, an address of a security gateway resident within a second wireless network is discovered. A key exchange is initiated with the security gateway to establish a secure tunnel, wherein the security gateway communicates with a home agent configured to allocate a home address for establishing a mobile tunnel within the secure tunnel. The security gateway and the home agent are within the second wireless network.

### RELATED APPLICATIONS

This application claims the benefit of the earlier filing date under 35 U.S.C. § 119(e) of U.S. Provisional Application Ser. No. 60/632,021 filed Dec. 1, 2004, entitled “Method and System For Providing Wireless Data Network Interworking,” the entirety of which is incorporated by reference.

### FIELD OF THE INVENTION

The invention relates to communications, and more particularly, to wireless data networking.

### BACKGROUND OF THE INVENTION

Radio communication systems, such as cellular systems and wireless local area networks (WLANs), provide users with the convenience of mobility. This convenience has spawned significant adoption by consumers as an accepted mode of communication for business and personal uses. Cellular service providers, for example, have fueled this acceptance by developing more enhanced network services and applications. In parallel, the prevalence of WLAN wireless technologies offers the possibility of achieving anywhere, any time connectivity to networking resources, such as Internet access. WLAN technology offers the advantage of high data rates, but is constrained by distance. Conversely, cellular systems support greater coverage, but are relatively limited in data rate. Consequently, the interworking of both cellular and WLAN technologies have received significant attention.

The development of cellular and WLAN systems has largely been independent and driven by differing engineering and business challenges. Not surprisingly, efficient signaling, in the context of interworking across disparate radio communication systems, has not been adequately addressed by the industry.

Therefore, there is a need for an approach for efficient signaling across many communication systems.

### SUMMARY OF THE INVENTION

These and other needs are addressed by the invention, in which an approach is presented for minimizing signaling overhead (e.g., tunneling overhead) associated with a wireless interworking architecture. A security gateway, such as a Packet Data Internetworking Function (PDIF), operates in conjunction with a Home Agent (HA), such that a mobile node appears to be on the home link. Additionally, the security gateway and the HA coordinate establishment of tunnels to forward the mobile node's traffic; the HA is made aware of where to forward traffic (to the PDIF) that is destined for the mobile node.

According to one aspect of an embodiment of the invention, a method comprises accessing a first wireless network. The method also comprises discovering, using the first wireless network, an address of a security gateway resident within a second wireless network. Further, the method comprises initiating a key exchange with the security gateway to establish a secure tunnel, wherein the security gateway communicates with a home agent configured to allocate a home address for establishing a mobile tunnel within the secure tunnel. The security gateway and the home agent are within the second wireless network.

According to another aspect of an embodiment of the invention, an apparatus comprises a communication interface configured to access a first wireless network. The apparatus also comprises a processor coupled to the communication interface and configured to discover, using the first wireless network, an address of a security gateway resident within a second wireless network, wherein the processor is further configured to initiate a key exchange with the security gateway to establish a secure tunnel. The security gateway communicates with a home agent configured to allocate a home address for establishing a mobile tunnel within the secure tunnel. The security gateway and the home agent are within the second wireless network.

According to another aspect of an embodiment of the invention, a method comprises receiving a request from a mobile station to initiate a key exchange for establishing a secure tunnel, wherein the mobile station accesses a first wireless network to determine where to send the request. The method also comprises communicating with a home agent configured to allocate a home address for establishing a mobile tunnel within the secure tunnel, wherein the home agent is within the second wireless network.

According to another aspect of an embodiment of the invention, an apparatus comprises a processor configured to initiate a key exchange for establishing a secure tunnel upon receipt of a request from a mobile station, wherein the mobile station accesses a first wireless network to determine where to send the request. The processor is further configured to initiate communication with a home agent configured to allocate a home address for establishing a mobile tunnel within the secure tunnel, the home agent residing within the second wireless network.

According to another aspect of an embodiment of the invention, a method comprises receiving an address request message from a security gateway, wherein the security gateway is configured to issue the address request message after receiving a request from a mobile station to initiate a key exchange for establishing a secure tunnel, wherein the mobile station accesses a first wireless network to determine where to send the request. The method further comprises allocating a home address for establishing a mobile tunnel within the secure tunnel.

According to another aspect of an embodiment of the invention, an apparatus comprises a communication interface configured to receive an address request message from a security gateway, wherein the security gateway is configured to issue the address request message after receiving a request from a mobile station to initiate a key exchange for establishing a secure tunnel. The mobile station accesses a first wireless network to determine where to send the request; the secure tunnel being over a second wireless network. The apparatus also comprises a processor coupled to the communication interface and configured to allocate a home address for establishing a mobile tunnel within the secure tunnel.

According to another aspect of an embodiment of the invention, an apparatus comprises means for accessing a first wireless network. The apparatus also comprises means for discovering, using the first wireless network, an address of a security gateway resident within a second wireless network. Further, the apparatus comprises means for initiating a key exchange with the security gateway to establish a secure tunnel, wherein the security gateway communicates with a home agent configured to allocate a home address for establishing a mobile tunnel within the secure tunnel. The security gateway and the home agent are within the second wireless network.

According to another aspect of an embodiment of the invention, an apparatus comprises means for receiving a request from a mobile station to initiate a key exchange for establishing a secure tunnel, wherein the mobile station accesses a first wireless network to determine where to send the request. The apparatus also comprises means for communicating with a home agent configured to allocate a home address for establishing a mobile tunnel within the secure tunnel, wherein the home agent is within the second wireless network.

According to yet another aspect of an embodiment of the invention, an apparatus comprises means for receiving an address request message from a security gateway, wherein the security gateway is configured to issue the address request message after receiving a request from a mobile station to initiate a key exchange for establishing a secure tunnel. The mobile station accesses a first wireless network to determine where to send the request. The apparatus also comprises means for allocating a home address for establishing a mobile tunnel within the secure tunnel.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The invention is illustrated by way of example, and not by way of limitation, in the figures of the accompanying drawings and in which like reference numerals refer to similar elements and in which:

FIG. 1 is a diagram of an interworking architecture for a wireless system, in accordance with an embodiment of the invention;

FIG. 2 is a flowchart of a process for extending the home link of the wireless system in FIG. 1, in accordance with an embodiment of the invention;

FIGS. 3 and 4 are ladder diagrams of the interaction between Packet Data Internetworking Function (PDIF) and a Home Agent of the system of FIG. 1, in accordance with an embodiment of the invention;

FIG. 5 is a diagram of a protocol structure for supporting PDIF Tunnel Inner Address (TIA) allocation option, in accordance with an embodiment of the invention;

FIG. 6 is a diagram of hardware that can be used to implement an embodiment of the invention.

FIG. 7 is a diagram of an exemplary cellular mobile phone system capable of supporting various embodiments of the invention;

FIG. 8 is a diagram of exemplary components of a mobile station capable of operating in the systems of FIG. 7, according to an embodiment of the invention; and

FIG. 9 is a diagram of an enterprise network capable of supporting the processes described herein, according to an embodiment of the invention.

### DESCRIPTION OF THE PREFERRED EMBODIMENT

An apparatus, method, and software for providing wireless data network interworking are described. In the following description, for the purposes of explanation, numerous specific details are set forth in order to provide a thorough understanding of the invention. It is apparent, however, to one skilled in the art that the invention may be practiced without these specific details or with an equivalent arrangement. In other instances, well-known structures and devices are shown in block diagram form in order to avoid unnecessarily obscuring the invention.

Although the various embodiments of the invention are described with respect to a wireless local area network and a spread spectrum cellular network, it is recognized and contemplated that the invention has applicability to other radio networks.

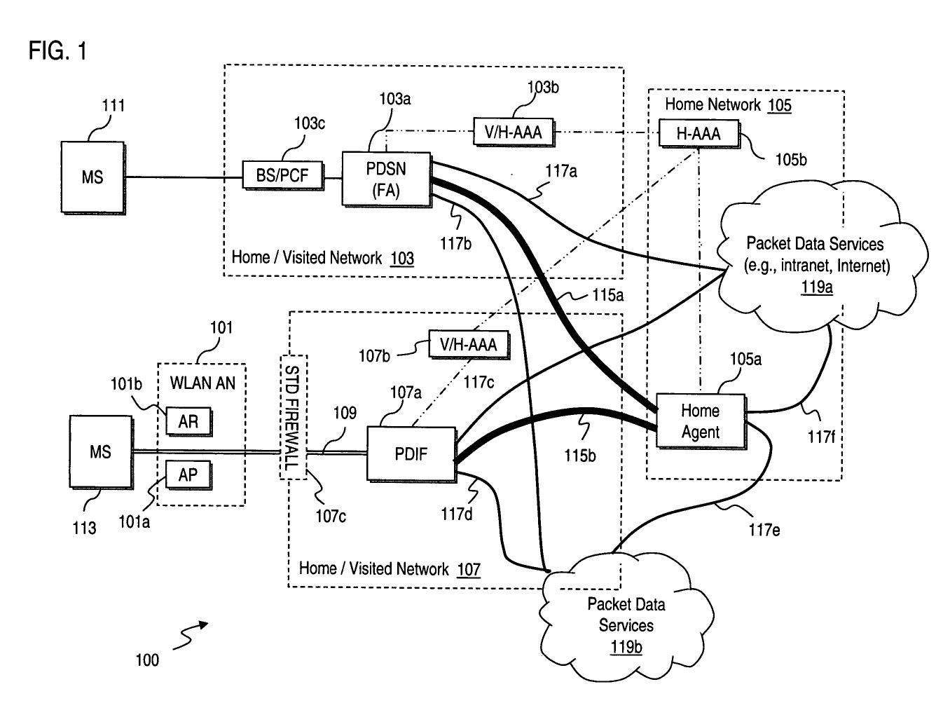

FIG. 1 is a diagram of an Interworking (IW) architecture of a wireless system capable of supporting voice and data services, in accordance with various embodiments of the present invention. A wireless system 100 has an Interworking (IW) architecture that provides QoS signaling between a wireless local area network (WLAN) and a spread spectrum system comprised of networks 103, 105 and 107. For the purposes of explanation, the spread spectrum system has a cdma2000 architecture for supporting transport of packets. According to one embodiment of the invention, the system 100 minimizes tunnel overhead associated with the Packet Data Internetworking Function (PDIF) and Home Agent (HA) interaction within a Code Division Multiple Access (CDMA) Wireless Local Area Network (WLAN) system.

The network 103 includes a Packet Data Serving Node (PDSN) 103a and an Authentication, Authorization, and Accounting (AAA) system 103b. The PDSN 103a aggregates data traffic from one or more Radio Network Controllers (RNCs) (not shown) and interfaces a Radio Access Network (RAN) (not shown) to a packet switched network. The PDSN 103a terminates a Point-to-Point (PPP) connection and maintains session state for each mobile station (MS) 111 (only one of which is shown) in its serving area. The mobile station (also denoted as mobile node or device) can be any variety of user equipment terminal—e.g., a mobile telephone, a personal digital assistant (PDA) with transceiver capability, or a personal computer with transceiver capability.

The radio network 107 includes a Packet Data Interworking Function (PDIF) entity 107a, which can interface with a Third Generation Partnership Project 2 (3GPP2) AAA infrastructure. The PDIF 107a may be located either in the home network or in a visited network. If the PDIF 107a is located in the home network then the PDIF 107a may be co-located with the Home Agent (HA) 105a. If the PDIF 107a is located in a visited network, this arrangement allows the WLAN user access to packet data services provided by the visited network 107.

The Packet Data Interworking Function (PDIF) entity 107a interfaces the WLAN access node (AN) 101 through a standard firewall 107c to the MS 113. The PDIF 107a, among other functions, serves as a security gateway between the Internet (not shown) and the packet data services; the PDIF 107a resides in the serving cdma2000 network (which may be a home network or a visited network). In addition, the PDIF 107a provides end-to-end secure tunnel management procedures between itself and the MS 113; these procedures include establishment and release of the tunnel, allocation of an network address (e.g., Internet Protocol (IP) address) to the MS 113, and traffic encapsulation and de-capsulation to and from the MS 113. Further, the PDIF 107a implements security policies (e.g., packet filtering and routing) of the network operator. In conjunction with the V/H (Visited/Home)-AAA 107b, the PDIF 107a supports user authentication and transfer of authorization policy information. The PDIF 107a also collects and transmits per-tunnel accounting information. The PDIF 107a is further detailed in described 3GPP2 X.S0028-200, entitled “Access to Operator Services and Mobility for WLAN Interworking” (which is incorporated herein by reference in its entirety).

The WLAN AN 101 includes an Access Point (AP) 101a for providing connectivity to the MS 113 as well as a router 101b that is configured to provide QoS capabilities (i.e., flow classification, marking, etc.). The networks 103 and 107 can be either a home or visited network. The home network 105 includes a home agent 105a and an AAA system 105b.

According to an exemplary embodiment, the interworking architecture of the system 100, among other capabilities, provides a secure end-to-end (e.g., Virtual Private Network (VPN)) tunnel 109 between the MS 113 and the PDIF 107a, which is a tunnel end-point. In the example of FIG. 1, the MS 111 connects to the PDSN 103a over, for example, a Point-to-Point Protocol (PPP) session. The PDSN 103a maintains a mobile IP tunnel 115a to the home agent 105a, which in turn carries a mobile IP tunnel 115b to the PDIF 107a. As shown, links 117a-117f within the system 100 include IP sessions (e.g., supporting mobile IPv6 Route Optimization (RO) operation) to communicate among the packet data services 119a, 119b, the PDSN 103a, the PDIF 107a, and the home agent 105a. Mobile IP permits a MS to communicate with a peer despite movement by the MS and changes in IP addresses. The RO mode of operation enables the use of a better (e.g., shorter) route to be used to reach the peer even though this better route is not through a home agent.

The concept behind mobile IP is to permit the home agent 105a to function as a stationary proxy for a mobile node (MN) (e.g., MS 111, 113). When the MS 111, for example, moves away from the home network, the home agent 105a intercepts packets destined for the home address (HoA) of the MS 111 and forwards the packets over a mobile IP tunnel to the current address of the MS 111—i.e., care-of-address (CoA). In this way, the transport layer sessions (e.g., Transmission Control Protocol (TCP) and User Datagram Protocol (UDP)) can use the HoA as a stationary identifier. Hence, tunnels are established through the home agent 105a, which can negatively impact network performance. To minimize the performance degradation, route optimization is utilized, whereby the mobile node sends the current CoA to a correspondent node using binding update messages.

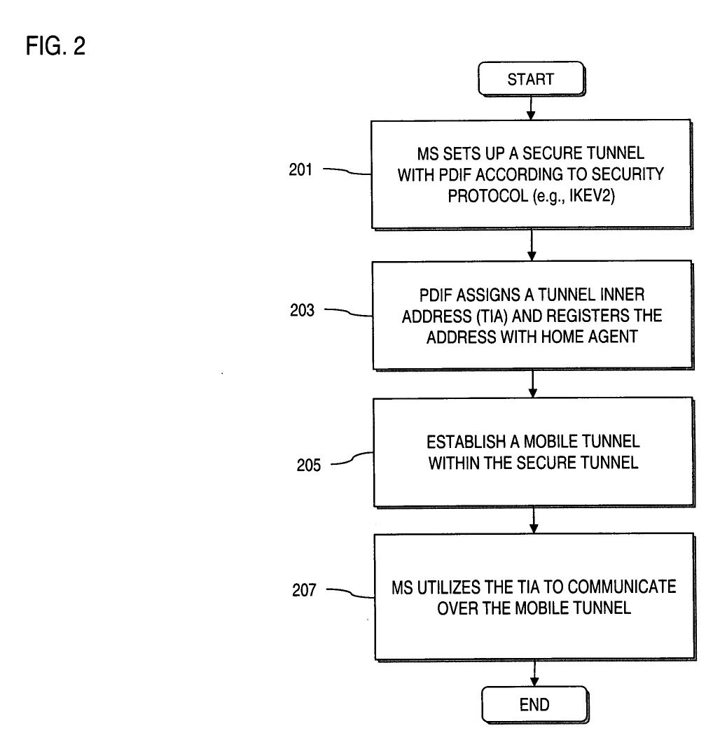

FIG. 2 shows a flowchart of a process for extending the home link within the system of FIG. 1. In step 201, the MS 113 sets up a secure tunnel to the PDIF 107a in order to access services on the home network. The secure tunnel is established using IPsec with optional MOBIKE (Internet Key Exchange v2 (IKEv2) Mobility and Multihoming) functionality to provide mobility for the IPsec tunnel when the MS 113 moves to another WLAN Access Network (AN) 101. MOBIKE is further detailed in an Internet Engineering Task Force (IETF) Internet-Draft dated Jun. 24, 2004 by T. Kivinen; the entirety of the document is incorporated herein by reference.

In an exemplary embodiment, for mobility between Packet Data System (PDS) and WLAN AN 101, Mobile IP is employed. This approach is described in IETF Request For Comment (RFC) 3344 and RFC 3775, where are incorporated herein by reference in their entireties. When the MS is attached to a Packet Data Service Node (PDSN) 103a, the MS 113 uses the address given out by the PDSN 103a as the Care of Address (CoA) for registration with the Home Agent. For IPv4, the PDSN 103a acts as a Foreign Agent.

When the Mobile Node (MN) 113 is attached to the WLAN access network 101, the MN 113 uses the Tunnel Inner Address (TIA) assigned by the PDIF 107a as the CoA, and registers the address with the Home Agent 105a (steps 203 and 205). The result is that a Mobile IP tunnel 115 is established inside the IPsec tunnel (step 207). The MS then utilizes the TIA to communicate over the mobile tunnel.

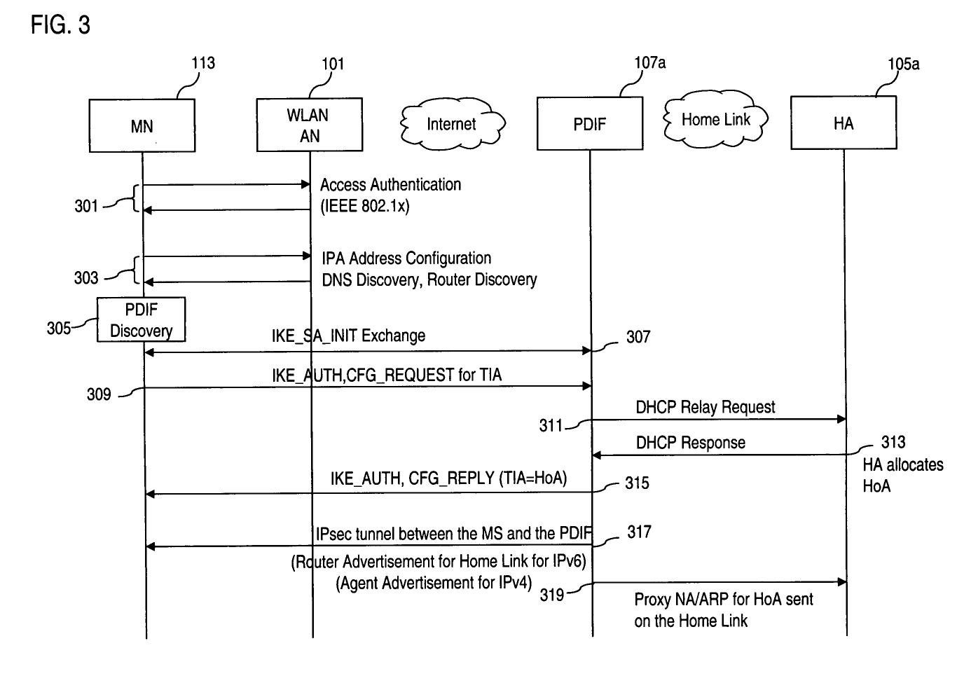

FIG. 3 describes the PDIF and HA interaction when the PDIF 107a and the HA 105a are located on the home link, according to an embodiment of the invention. The MS 113 authenticates, as in step 301, to the WLAN AN 101 and obtains access to the Internet. This may involve the WLAN AN 101 checking with the Home Authentication, Authorization and Accounting (H-AAA) 105b for authorization.

The MS 113 configures an IP address from the Access Network, per step 303. The MS 113 also discovers the default router and the Domain Name System (DNS) server address. In step 305, the MS 113 discovers the PDIF address; the PDIF discovery may be performed using standard DNS mechanism or any other (for example, the network may provide the IP address of the PDIF 107a). Next, the MS 113 initiates IKE exchange with the PDIF 107a, as in step 307. The first sets of messages involve IKE_SA_INIT exchange. The MS 113 includes a Configuration Payload in the IKE_AUTH exchange message (i.e., CFG_REQUEST message), with a request for a Tunnel Inner Address (TIA), per step 309. The TIA address, according to one embodiment of the invention, can be obtained from the VPN gateway (not shown), whenever a Virtual Private Network (VPN) client sets up an IPsec VPN tunnel with the VPN gateway.

When the PDIF 107a receives the request from the MS (if the PDIF 107a is located on the same link as the home link for the MS 113), the PDIF 107a sends a Dynamic Host Configuration Protocol (DHCP) relay request to the HA 105a, as in step 311. Thereafter, the HA 105a allocates a Home Address (HoA) and responds to the PDIF 107a with a DHCP Response, per step 313. In case the HA 105a is also a DHCP relay agent, the HA 105a sends a DHCP request to the actual DHCP server on the home link and obtains a HoA. In other words, when the HA 105a receives a DHCP relay request message from the PDIF 107a, the HA 105a allocates a HoA and replies to the PDIF 107a. If the HA 105a is a DHCP relay agent, it then sends a DHCP relay request message to the DHCP server on the home link and obtains a HoA.

The PDIF 107a completes the IKE_AUTH exchange. The PDIF includes the Home Address in the Configuration Payload, which contains the CFG_REPLY (configuration reply) message (step 315). When the IKE_AUTH exchange completes, an IPsec tunnel is established between the MS 113 and the PDIF 107a (step 317). That is, when the HA 105a replies with a HoA, the PDIF 107a sends the HoA as the TIA in the CFG_REPLY message in the Configuration Payload.

The MS 113 compares the TIA with the prefix of the home link. If the prefix for TIA is the same the prefix on the home link, the MN 113 treats the tunnel to the PDIF 107a as a single hop link to a router on the home link. In case the MS 113 has a statically assigned HoA, the MS 113 compares the TIA with the static HoA to check if the MS 113 is on the home link.

The PDIF 107a also sends a router advertisement through the MN-PDIF VPN tunnel. The router advertisement contains the same prefix that is advertised by the Home Agent on the home link. In case of IPv4, the PDIF 107a sends an Agent Advertisement on behalf of the Home Agent to the MS 113 through the IPsec tunnel. In case of IPv6, the PDIF 107a sends a Router Advertisement for the home prefix through the IPsec tunnel. The above two steps give an impression of being on the home link to the MS 113.

If the packets destined for the HoA of the MS 113 are not automatically routed to the PDIF 107a, then the PDIF 107a sends, as in step 319, a Proxy Neighbor Advertisement (NA) (as detailed in IETF RFC 2461, which is incorporated herein by reference in its entirety) for the MS's HoA. In case of IPv4, the PDIF 107a needs to send a Proxy Address Resolution Protocol (ARP) message for the MS's HoA.

As long as the MS 113 is on the WLAN AN 101 and attached to the PDIF 107a on the home link, it is on the home link as far as Mobile IP is concerned. When the MS 113 roams and attaches to a PDSN 103a, the MS 113 assumes it has moved from the home network to a visited network and sends a Binding Update to the Home Agent 105a. The MS 113 continues using the same HoA that it acquired when on the WLAN AN 101.

In case the MS 113 has a statically assigned HoA, then the MS 113 compares the TIA allocated by the PDIF 107a with the prefix of the static HoA. If the prefix is the same, the MS 113 assumes it is on the home link. The MS 113 uses the TIA as the new temporarily assigned HoA and starts sessions based on the TIA. The Mobile IP specifications allow for multiple home addresses for a MS 113.

In an alternative embodiment, the PDIF 107a need not send a Proxy NA/ARP message, as described below.

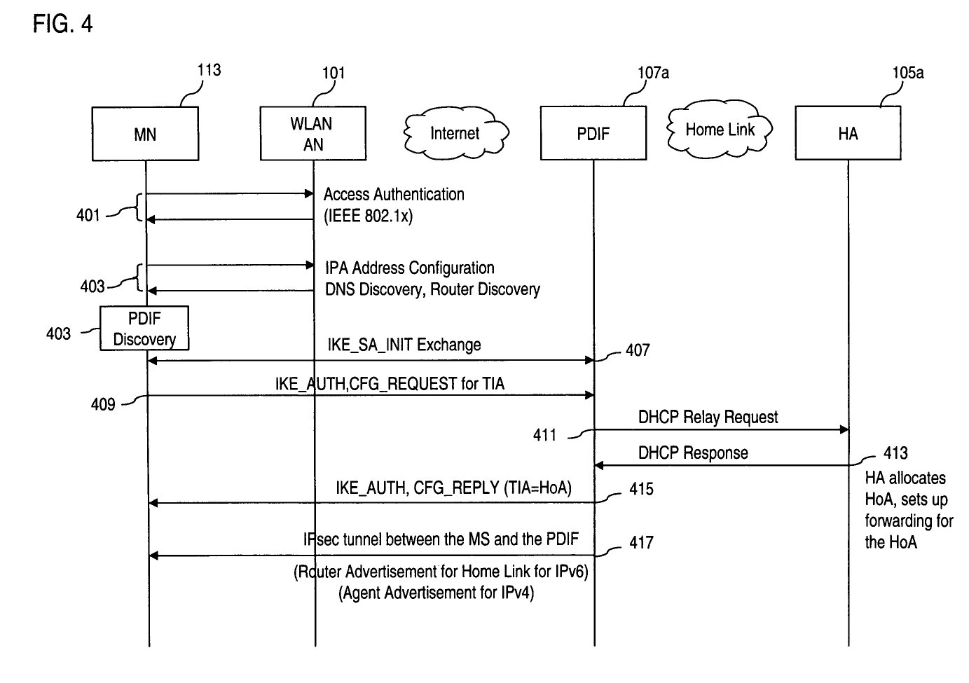

FIG. 4 shows a scenario in which no Proxy NA/ARP message is required to be sent to the home agent. When the PDIF 107a sends a Proxy NA/ARP (Neighbor Advertisement/Address Resolution Protocol) message for the MS's HoA, the PDIF 107a basically assumes the role of a Home Agent 105a for the MS's HoA. This scenario describes an alternative mechanism to ensure that the packets meant for the MS's HoA that reach the Home Network are delivered to the PDIF 107a. The mechanism is similar to the process of FIG. 3; notably steps 301-317 correspond largely to steps 401-417.

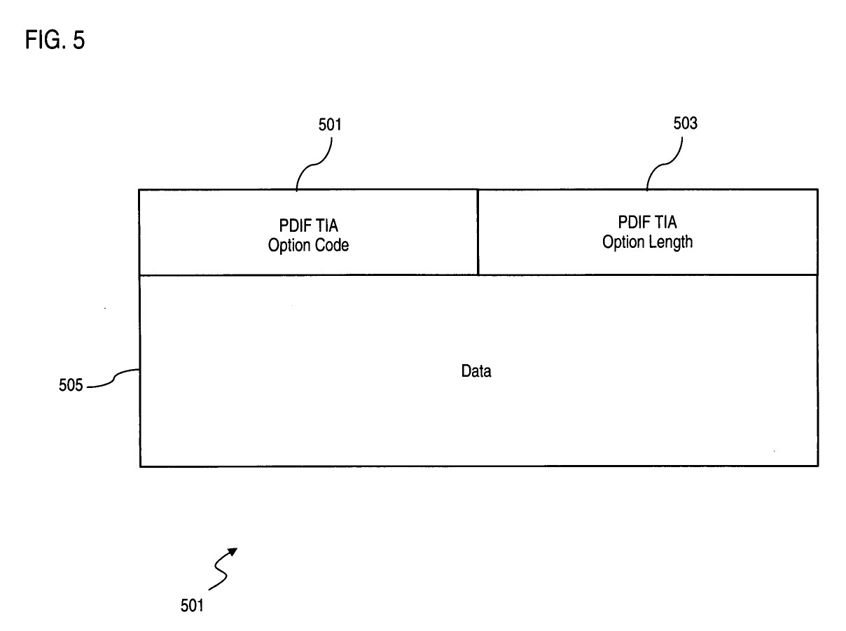

However, the PDIF 107a in the DHCP relay request, in step 411, includes a Vendor Specific Option, as described in IETF RFC 3315 (which is incorporated herein by reference in its entirety), to indicate to the Home Agent 105a that it is actually requesting a HoA for a MS 113 that is currently establishing an IPsec tunnel 109. In other words, if the DHCP request includes the PDIF TIA Allocation option indicating that the HoA is actually for the remote MS 113, the Home Agent 105a, when it processes the option, sets up forwarding for the MS's HoA with the next hop set to the PDIF 107a. When the Home Agent 105a subsequently receives a packet destined for the MS's HoA, the HA 105a forwards the packet to the PDIF 107a. This option is denoted as the PDIF TIA Allocation option and is illustrated in FIG. 5.

FIG. 5 is a diagram of a data structure for supporting a PDIF Tunnel Inner Address (TIA) allocation option, in accordance with an embodiment of the invention. The data structure 500 includes an option code 501, which specifies information allocated from the 3GPP2 vendor for a specific DHCP (Dynamic Host Configuration Protocol) option space. An option length 503 is allocated for set to the size option. The data structure 505 also provides an optional data field 505.

When the Home Agent 105a processes this option, in addition to allocating a HoA for the MS 113, it also sets up forwarding for the HoA with the next hop set to the PDIF 107a. If the packets meant for the MS's HoA reaches the Home Agent 105a, the Home Agent 105a forwards the packets to the PDIF 107a. This advantageously avoids the need for the PDIF 107a to send a Proxy NA/ARP message for the MS's HoA.

The mechanism described above advantageously reduces the tunnel overhead when the PDIF 107a and the HA 105a are located on the same home link.

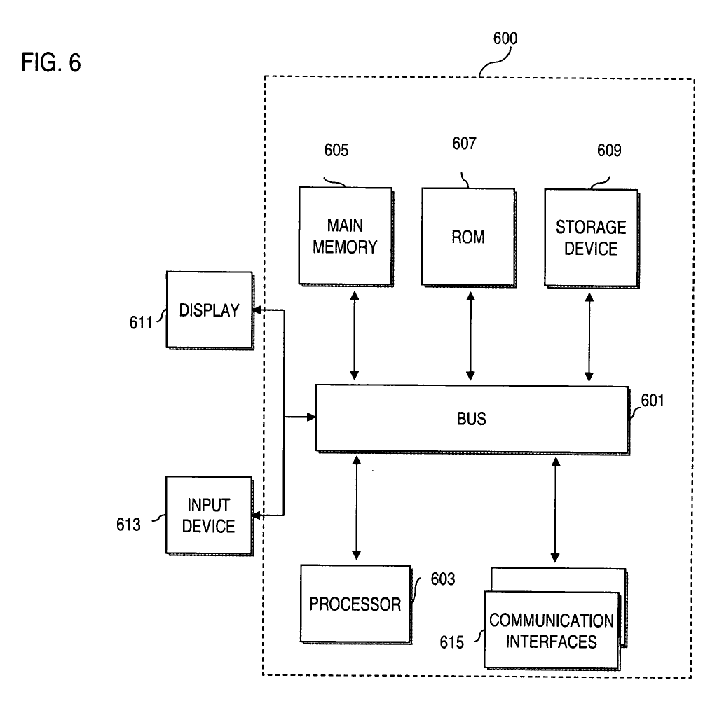

FIG. 6 illustrates exemplary hardware upon which an embodiment according to the present invention can be implemented. A computing system 600 includes a bus 601 or other communication mechanism for communicating information and a processor 603 coupled to the bus 601 for processing information. The computing system 600 also includes main memory 605, such as a random access memory (RAM) or other dynamic storage device, coupled to the bus 601 for storing information and instructions to be executed by the processor 603. Main memory 605 can also be used for storing temporary variables or other intermediate information during execution of instructions by the processor 603. The computing system 600 may further include a read only memory (ROM) 607 or other static storage device coupled to the bus 601 for storing static information and instructions for the processor 603. A storage device 609, such as a magnetic disk or optical disk, is coupled to the bus 601 for persistently storing information and instructions.

The computing system 600 may be coupled via the bus 601 to a display 611, such as a liquid crystal display, or active matrix display, for displaying information to a user. An input device 613, such as a keyboard including alphanumeric and other keys, may be coupled to the bus 601 for communicating information and command selections to the processor 603. The input device 613 can include a cursor control, such as a mouse, a trackball, or cursor direction keys, for communicating direction information and command selections to the processor 603 and for controlling cursor movement on the display 611.

According to various embodiments of the invention, the processes of FIGS. 2-4 can be provided by the computing system 600 in response to the processor 603 executing an arrangement of instructions contained in main memory 605. Such instructions can be read into main memory 605 from another computer-readable medium, such as the storage device 609. Execution of the arrangement of instructions contained in main memory 605 causes the processor 603 to perform the process steps described herein. One or more processors in a multi-processing arrangement may also be employed to execute the instructions contained in main memory 605. In alternative embodiments, hard-wired circuitry may be used in place of or in combination with software instructions to implement the embodiment of the present invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the present invention are not limited to any specific combination of hardware circuitry and software.

The computing system 600 also includes at least one communication interface 615 coupled to bus 601. The communication interface 615 provides a two-way data communication coupling to a network link (not shown). The communication interface 615 sends and receives electrical, electromagnetic, or optical signals that carry digital data streams representing various types of information. Further, the communication interface 615 can include peripheral interface devices, such as a Universal Serial Bus (USB) interface, a PCMCIA (Personal Computer Memory Card International Association) interface, etc.

The processor 603 may execute the transmitted code while being received and/or store the code in the storage device 609, or other non-volatile storage for later execution. In this manner, the computing system 600 may obtain application code in the form of a carrier wave.

The term “computer-readable medium” as used herein refers to any medium that participates in providing instructions to the processor 603 for execution. Such a medium may take many forms, including but not limited to non-volatile media, volatile media, and transmission media. Non-volatile media include, for example, optical or magnetic disks, such as the storage device 609. Volatile media include dynamic memory, such as main memory 605. Transmission media include coaxial cables, copper wire and fiber optics, including the wires that comprise the bus 601. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

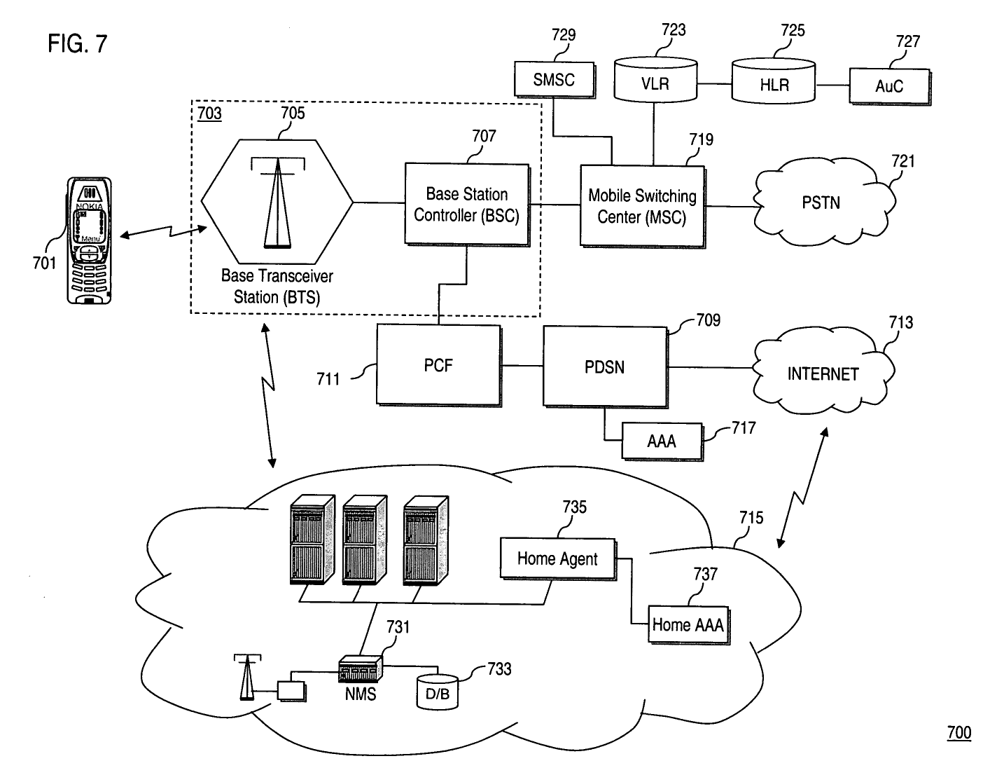

FIG. 7 is a diagram of an exemplary cellular mobile phone system capable of supporting various embodiments of the invention. The exemplary cellular mobile phone system 700 utilizes a mobile station (e.g., handset) and base station having a transceiver installed (as part of a Digital Signal Processor (DSP)), hardware, software, an integrated circuit, and/or a semiconductor device in the base station and mobile station). By way of example, the radio network supports Second and Third Generation (2G and 3G) services as defined by the International Telecommunications Union (ITU) for International Mobile Telecommunications 2000 (IMT-2000). For the purposes of explanation, the carrier and channel selection capability of the radio network is explained with respect to a cdma2000 architecture. As the third-generation version of IS-95, cdma2000 is being standardized in the Third Generation Partnership Project 2 (3GPP2).

A radio network 700 includes mobile stations 701 (e.g., handsets, terminals, stations, units, devices, or any type of interface to the user (such as “wearable” circuitry, etc.)) in communication with a Base Station Subsystem (BSS) 703. According to one embodiment of the invention, the radio network supports Third Generation (3G) services as defined by the International Telecommunications Union (ITU) for International Mobile Telecommunications 2000 (IMT-2000).

In this example, the BSS 703 includes a Base Transceiver Station (BTS) 705 and Base Station Controller (BSC) 707. Although a single BTS is shown, it is recognized that multiple BTSs are typically connected to the BSC through, for example, point-to-point links. Each BSS 703 is linked to a Packet Data Serving Node (PDSN) 709 through a transmission control entity, or a Packet Control Function (PCF) 711. Since the PDSN 709 serves as a gateway to external networks, e.g., the Internet 713 or other private consumer networks 715, the PDSN 709 can include an Access, Authorization and Accounting system (AAA) 717 to securely determine the identity and privileges of a user and to track each user's activities. The network 715 comprises a Network Management System (NMS) 731 linked to one or more databases 733 that are accessed through a Home Agent (HA) 735 secured by a Home AAA 737.

Although a single BSS 703 is shown, it is recognized that multiple BSSs 703 are typically connected to a Mobile Switching Center (MSC) 719. The MSC 719 provides connectivity to a circuit-switched telephone network, such as the Public Switched Telephone Network (PSTN) 721. Similarly, it is also recognized that the MSC 719 may be connected to other MSCs 719 on the same network 700 and/or to other radio networks. The MSC 719 is generally collocated with a Visitor Location Register (VLR) 723 database that holds temporary information about active subscribers to that MSC 719. The data within the VLR 723 database is to a large extent a copy of the Home Location Register (HLR) 725 database, which stores detailed subscriber service subscription information. In some implementations, the HLR 725 and VLR 723 are the same physical database; however, the HLR 725 can be located at a remote location accessed through, for example, a Signaling System Number 7 (SS7) network. An Authentication Center (AuC) 727 containing subscriber-specific authentication data, such as a secret authentication key, is associated with the HLR 725 for authenticating users. Furthermore, the MSC 719 is connected to a Short Message Service Center (SMSC) 729 that stores and forwards short messages to and from the radio network 700.

During typical operation of the cellular telephone system, BTSs 705 receive and demodulate sets of reverse-link signals from sets of mobile units 701 conducting telephone calls or other communications. Each reverse-link signal received by a given BTS 705 is processed within that station. The resulting data is forwarded to the BSC 707. The BSC 707 provides call resource allocation and mobility management functionality including the orchestration of soft handoffs between BTSs 705. The BSC 707 also routes the received data to the MSC 719, which in turn provides additional routing and/or switching for interface with the PSTN 721. The MSC 719 is also responsible for call setup, call termination, management of inter-MSC handover and supplementary services, and collecting, charging and accounting information. Similarly, the radio network 700 sends forward-link messages. The PSTN 721 interfaces with the MSC 719. The MSC 719 additionally interfaces with the BSC 707, which in turn communicates with the BTSs 705, which modulate and transmit sets of forward-link signals to the sets of mobile units 701.

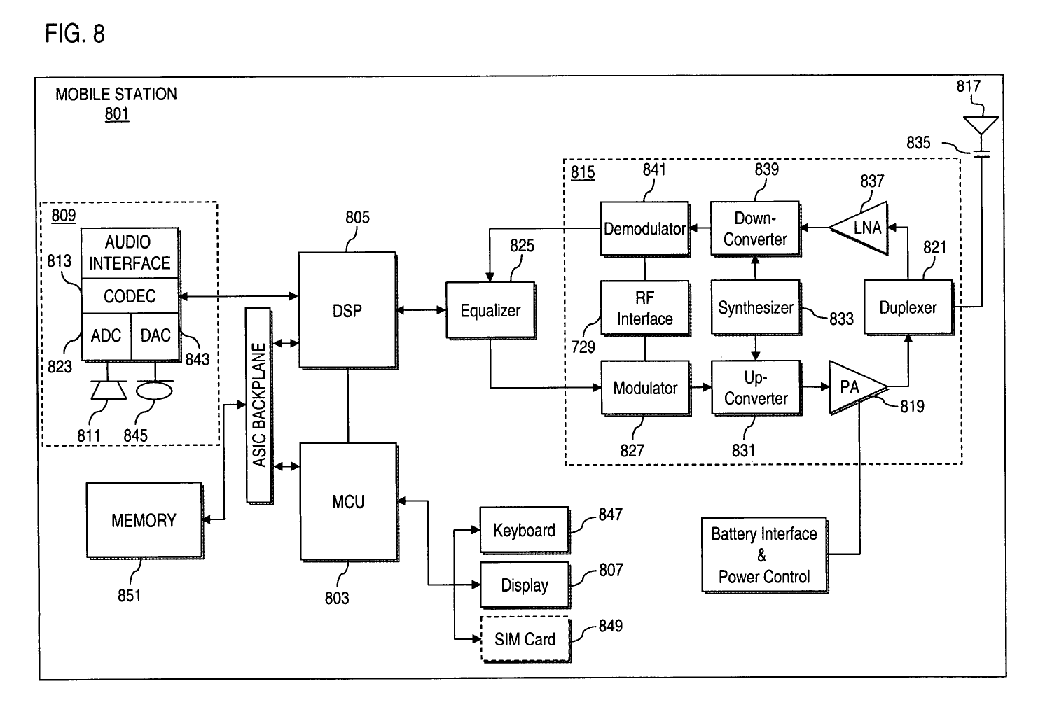

FIG. 8 is a diagram of exemplary components of a mobile station (e.g., handset) capable of operating in the system of FIG. 7, according to an embodiment of the invention. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile station functions. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system (e.g., system of FIG. 7), via antenna 817. The power amplifier (PA) 819 and the transmitter/modulation circuitry are operationally responsive to the MCU 803, with an output from the PA 819 coupled to the duplexer 821 or circulator or antenna switch, as known in the art.

In use, a user of mobile station 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In the exemplary embodiment, the processed voice signals are encoded, by units not separately shown, using the cellular transmission protocol of Code Division Multiple Access (CDMA), as described in detail in the Telecommunication Industry Association's TIA/EIA/IS-95-A Mobile Station-Base Station Compatibility Standard for Dual-Mode Wideband Spread Spectrum Cellular System; which is incorporated herein by reference in its entirety.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803—which can be implemented as a Central Processing Unit (CPU) (not shown).

The MCU 803 receives various signals including input signals from the keyboard 847. The MCU 803 delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the station. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile station 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile station 801 on a radio network. The card 849 also contains a memory for storing a personal telephone number registry, text messages, and user specific mobile station settings.

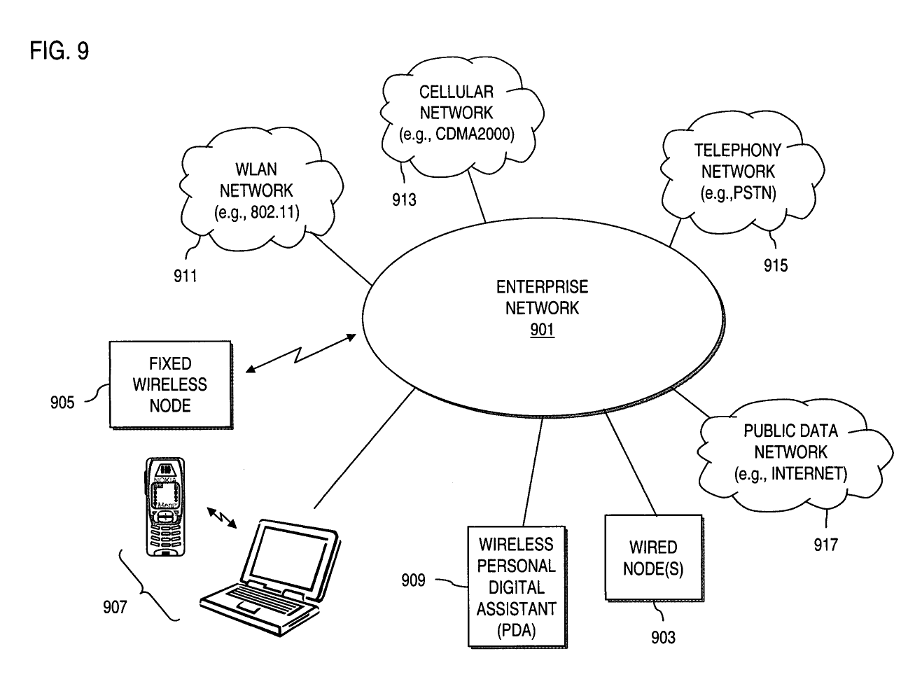

FIG. 9 shows an exemplary enterprise network, which can be any type of data communication network utilizing packet-based and/or cell-based technologies (e.g., Asynchronous Transfer Mode (ATM), Ethernet, IP-based, etc.). The enterprise network 901 provides connectivity for wired nodes 903 as well as wireless nodes 905-909 (fixed or mobile), which are each configured to perform the processes described above. The enterprise network 901 can communicate with a variety of other networks, such as a WLAN network 911 (e.g., IEEE 802.11), a cdma2000 cellular network 913, a telephony network 915 (e.g., PSTN), or a public data network 917 (e.g., Internet).

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
accessing a first wireless network;
discovering, using the first wireless network, an address of a security gateway resident within a second wireless network; and
initiating a key exchange with the security gateway to establish a secure tunnel, wherein the security gateway communicates with a home agent configured to allocate a home address for establishing a mobile tunnel within the secure tunnel,
wherein the security gateway and the home agent are within the second wireless network.

2. A method according to claim 1, wherein the first wireless network includes an access node that communicates with an Authentication, Authorization and Accounting server within the second wireless network to authenticate access to the first wireless network.

3. A method according to claim 1, wherein the first wireless network includes a wireless local area network (WLAN) access network and the second wireless network includes a cellular network.

4. A method according to claim 1, further comprising:
requesting, as part of the key exchange, a tunnel inner address corresponding to the mobile tunnel from a virtual private network (VPN) gateway.

5. A method according to claim 4, further comprising:
comparing the tunnel inner address with a prefix of the second wireless network to determine whether the secure tunnel can be treated as a single hop to a router within the second wireless network.

6. A method according to claim 5, wherein the security gateway sends an advertisement message containing the prefix to the home agent.

7. A method according to claim 1, wherein the security gateway is further configured to provide the home address within a key exchange message as part of the key exchange.

8. A method according to claim 1, wherein the security gateway is further configured to send a proxy neighbor advertisement message to the home agent.

9. A method according to claim 1, wherein the security gateway is further configured to send a Dynamic Host Configuration Protocol (DHCP) relay request message to the home agent, the relay request message including an option code to indicate to the home agent that the home address is requested for a mobile station.

10. A method according to claim 1, wherein the security gateway includes a packet data interworking function module that is configured to provide end-to-end secure tunnel management procedures with the mobile station.

11. An apparatus comprising:
a communication interface configured to access a first wireless network; and
a processor coupled to the communication interface and configured to discover, using the first wireless network, an address of a security gateway resident within a second wireless network, wherein the processor is further configured to initiate a key exchange with the security gateway to establish a secure tunnel, the security gateway communicating with a home agent configured to allocate a home address for establishing a mobile tunnel within the secure tunnel,
wherein the security gateway and the home agent are within the second wireless network.

12. An apparatus according to claim 11, wherein the first wireless network includes an access node that communicates with an Authentication, Authorization and Accounting server within the second wireless network to authenticate access to the first wireless network.

13. An apparatus according to claim 11, wherein the first wireless network includes a wireless local area network (WLAN) access network and the second wireless network includes a cellular network.

14. An apparatus according to claim 11, wherein the processor is further configured to request, as part of the key exchange, a tunnel inner address corresponding to the mobile tunnel from a virtual private network (VPN) gateway.

15. An apparatus according to claim 14, wherein the processor is further configured to compare the tunnel inner address with a prefix of the second wireless network to determine whether the secure tunnel can be treated as a single hop to a router within the second wireless network.

16. An apparatus according to claim 15, wherein the security gateway sends an advertisement message containing the prefix to the home agent.

17. An apparatus according to claim 11, wherein the security gateway is further configured to provide the home address within a key exchange message as part of the key exchange.

18. An apparatus according to claim 11, wherein the security gateway is further configured to send a proxy neighbor advertisement message to the home agent.

19. An apparatus according to claim 11, wherein the security gateway is further configured to send a Dynamic Host Configuration Protocol (DHCP) relay request message to the home agent, the relay request message including an option code to indicate to the home agent that the home address is requested for a mobile station.

20. An apparatus according to claim 11, wherein the security gateway includes a packet data interworking function module that is configured to provide end-to-end secure tunnel management procedures with the mobile station.

21. A method comprising:
receiving a request from a mobile station to initiate a key exchange for establishing a secure tunnel, wherein the mobile station accesses a first wireless network to determine where to send the request; and
communicating with a home agent configured to allocate a home address for establishing a mobile tunnel within the secure tunnel,
wherein the home agent is within the second wireless network.

22. A method according to claim 21, wherein the first wireless network includes an access node that communicates with an Authentication, Authorization and Accounting server within the second wireless network to authenticate access to the first wireless network.

23. A method according to claim 21, wherein the first wireless network includes a wireless local area network (WLAN) access network and the second wireless network includes a cellular network.

24. A method according to claim 21, further comprising:
sending a tunnel inner address corresponding to the mobile tunnel to the mobile station.

25. A method according to claim 24, wherein the mobile station is configured to compare the tunnel inner address with a prefix of the second wireless network to determine whether the secure tunnel can be treated as a single hop to a router within the second wireless network.

26. A method according to claim 25, wherein the security gateway sends an advertisement message containing the prefix to the home agent.

27. A method according to claim 21, further comprising:
including the home address within a key exchange message as part of the key exchange.

28. A method according to claim 21, further comprising:
sending a proxy neighbor advertisement message to the home agent.

29. A method according to claim 21, further comprising:
sending a Dynamic Host Configuration Protocol (DHCP) relay request message to the home agent, the relay request message including an option code to indicate to the home agent that the home address is requested for a mobile station.

30. A method according to claim 21, further comprising:
providing end-to-end secure tunnel management procedures with the mobile station.

31. An apparatus comprising:
a processor configured to initiate a key exchange for establishing a secure tunnel upon receipt of a request from a mobile station, wherein the mobile station accesses a first wireless network to determine where to send the request,
wherein the processor is further configured to initiate communication with a home agent configured to allocate a home address for establishing a mobile tunnel within the secure tunnel, the home agent residing within the second wireless network.

32. An apparatus according to claim 31, wherein the first wireless network includes an access node that communicates with an Authentication, Authorization and Accounting server within the second wireless network to authenticate access to the first wireless network.

33. An apparatus according to claim 31, wherein the first wireless network includes a wireless local area network (WLAN) access network and the second wireless network includes a cellular network.

34. An apparatus according to claim 31, further comprising:
a communications interface coupled to the processor and configured to send a tunnel inner address corresponding to the mobile tunnel to the mobile station.

35. An apparatus according to claim 34, wherein the mobile station is configured to compare the tunnel inner address with a prefix of the second wireless network to determine whether the secure tunnel can be treated as a single hop to a router within the second wireless network.

36. An apparatus according to claim 35, wherein the security gateway is further configured to send an advertisement message containing the prefix to the home agent.

37. An apparatus according to claim 31, wherein the processor is further configured to include the home address within a key exchange message as part of the key exchange.

38. An apparatus according to claim 31, further comprising:
a communications interface coupled to the processor and configured to send a proxy neighbor advertisement message to the home agent.

39. An apparatus according to claim 31, further comprising:
a communications interface coupled to the processor and configured to send a Dynamic Host Configuration Protocol (DHCP) relay request message to the home agent, the relay request message including an option code to indicate to the home agent that the home address is requested for a mobile station.

40. An apparatus according to claim 31, wherein the processor is further configured to provide end-to-end secure tunnel management procedures with the mobile station.

41. A method comprising:
receiving an address request message from a security gateway, wherein the security gateway is configured to issue the address request message after receiving a request from a mobile station to initiate a key exchange for establishing a secure tunnel, wherein the mobile station accesses a first wireless network to determine where to send the request; and
allocating a home address for establishing a mobile tunnel within the secure tunnel.

42. A method according to claim 41, wherein the first wireless network includes an access node that communicates with an Authentication, Authorization and Accounting server within the second wireless network to authenticate access to the first wireless network.

43. A method according to claim 41, wherein the first wireless network includes a wireless local area network (WLAN) access network and the second wireless network includes a cellular network.

44. A method according to claim 41, wherein the security gateway is further configured to send a tunnel inner address corresponding to the mobile tunnel to the mobile station.

45. A method according to claim 44, wherein the mobile station is configured to compare the tunnel inner address with a prefix of the second wireless network to determine whether the secure tunnel can be treated as a single hop to a router within the second wireless network.

46. A method according to claim 45, further comprising:
receiving, from the security gateway, an advertisement message containing the prefix.

47. A method according to claim 41, wherein the security gateway is further configured to include the home address within a key exchange message as part of the key exchange.

48. A method according to claim 41, further comprising:
receiving a proxy neighbor advertisement message from the security gateway.

49. A method according to claim 41, wherein the address request message is a Dynamic Host Configuration Protocol (DHCP) relay request message, the relay request message including an option code to indicate to the home agent that the home address is requested for a mobile station.

50. A method according to claim 41, wherein the security gateway is further configured to provide end-to-end secure tunnel management procedures with the mobile station.

51. An apparatus comprising:
a communication interface configured to receive an address request message from a security gateway, wherein the security gateway is configured to issue the address request message after receiving a request from a mobile station to initiate a key exchange for establishing a secure tunnel, wherein the mobile station accesses a first wireless network to determine where to send the request; and
a processor coupled to the communication interface and configured to allocate a home address for establishing a mobile tunnel within the secure tunnel.

52. An apparatus according to claim 51, wherein the first wireless network includes an access node that communicates with an Authentication, Authorization and Accounting server within the second wireless network to authenticate access to the first wireless network.

53. An apparatus according to claim 51, wherein the first wireless network includes a wireless local area network (WLAN) access network and the second wireless network includes a cellular network.

54. An apparatus according to claim 51, wherein the security gateway is further configured to send a tunnel inner address corresponding to the mobile tunnel to the mobile station.

55. An apparatus according to claim 54, wherein the mobile station is configured to compare the tunnel inner address with a prefix of the second wireless network to determine whether the secure tunnel can be treated as a single hop to a router within the second wireless network.

56. An apparatus according to claim 55, wherein the communication interface is further configured to receive, from the security gateway, an advertisement message containing the prefix.

57. An apparatus according to claim 51, wherein the security gateway is further configured to include the home address within a key exchange message as part of the key exchange.

58. An apparatus according to claim 51, wherein the communication interface is further configured to receive a proxy neighbor advertisement message from the security gateway.

59. An apparatus according to claim 51, wherein the address request message is a Dynamic Host Configuration Protocol (DHCP) relay request message, the relay request message including an option code to indicate to the home agent that the home address is requested for a mobile station.

60. An apparatus according to claim 51, wherein the security gateway is further configured to provide end-to-end secure tunnel management procedures with the mobile station.

61. An apparatus comprising:
means for accessing a first wireless network;
means for discovering, using the first wireless network, an address of a security gateway resident within a second wireless network; and
means for initiating a key exchange with the security gateway to establish a secure tunnel, wherein the security gateway communicates with a home agent configured to allocate a home address for establishing a mobile tunnel within the secure tunnel,
wherein the security gateway and the home agent are within the second wireless network.

62. An apparatus according to claim 61, wherein the first wireless network includes a wireless local area network (WLAN) access network and the second wireless network includes a cellular network.

63. An apparatus comprising:
means for receiving a request from a mobile station to initiate a key exchange for establishing a secure tunnel, wherein the mobile station accesses a first wireless network to determine where to send the request; and
means for communicating with a home agent configured to allocate a home address for establishing a mobile tunnel within the secure tunnel,
wherein the home agent is within the second wireless network.

64. An apparatus according to claim 63, wherein the first wireless network includes a wireless local area network (WLAN) access network and the second wireless network includes a cellular network.

65. An apparatus comprising:
means for receiving an address request message from a security gateway, wherein the security gateway is configured to issue the address request message after receiving a request from a mobile station to initiate a key exchange for establishing a secure tunnel, wherein the mobile station accesses a first wireless network to determine where to send the request; and
means for allocating a home address for establishing a mobile tunnel within the secure tunnel.

66. An apparatus according to claim 65, wherein the first wireless network includes a wireless local area network (WLAN) access network and the second wireless network includes a cellular network.
